(19) United States
(12) Patent Application Publication
(10) Pub. No.: US 2026/0342087 A1
(43) Pub. Date: Oct. 29, 2026

(54) SMART SCHEDULING FOR APPLIANCES OF ENERGY MANAGEMENT SYSTEM

(71) Applicant: Enphase Energy, Inc., Fremont, CA (US)

(72) Inventors: Rahul Kumar AGRAWAL, Bangalore (IN); Vidyasagar Venkata NALLAPATI, Bangalore (IN); Rohit HARLALKA, Bangalore (IN); Ravi Kumar PARVELA, Cupertino, CA (US)

(21) Appl. No.: 19/655,443

(22) Filed: Apr. 22, 2026

Related U.S. Application Data
(60) Provisional application No. 63/796,573, filed on Apr. 29, 2025.

(51) Int. Cl. H02J 3/14; G05B 13/04; H02J 3/32; H02J 3/38; H02J 101/24; H02J 105/50

(52) U.S. Cl. CPC H02J 3/14; G05B 13/048; H02J 3/32; H02J 3/38; H02J 2101/24; H02J 2105/57

(57) ABSTRACT

An apparatus configured for use with an energy management system is provided and comprises an energy scheduling optimization module configured to automatically receive site information, perform energy scheduling optimization for a load based on the site information, and generate a recommended energy schedule for the load based on the energy scheduling optimization.

### CROSS-REFERENCE TO RELATED APPLICATIONS

The present application claims the benefit of and priority to U.S. Provisional Application Serial No. 63/796,573, filed on Apr. 29, 2025, the entire contents of which is incorporated herein by reference.

### BACKGROUND

### Field of the Disclosure

Embodiments of the present disclosure relate generally to energy management systems, and, for example, to methods and apparatus configured for smart scheduling for appliances of energy management systems.

### Description of the Related Art

Energy management systems are known. Such systems are configured to provide power to one or more appliances when off-grid (e.g., power outage). Some energy management systems can be associated with a site ID for monitoring one or more operations and/or components (e.g., loads, DER, appliances, etc.) of the energy management systems. For a given a site ID (and associated metadata and/or telemetry data), and an appliance with known power consumption and runtime, evaluating an optimal charging schedule for the appliance based on a user defined system objective (e.g., self-consumption or savings) can be rather difficult.

Thus, the inventors describe herein an improved methods and apparatus configured for smart scheduling for appliances of energy management systems.

### SUMMARY

In accordance with aspects of the present disclosure there is provided a non-transitory computer readable storage medium having instructions stored thereon that when executed by a processor performs a method for optimizing efficient use of energy via smart scheduling of loads. The method comprises automatically receiving site information, performing energy scheduling optimization for a load based on the site information, and generating a recommended energy schedule for the load based on the energy scheduling optimization.

In accordance with aspects of the present disclosure there is provided a method for optimizing efficient use of energy via smart scheduling of loads. The method comprises automatically receiving site information, performing energy scheduling optimization for a load based on the site information, and generating a recommended energy schedule for the load based on the energy scheduling optimization.

In accordance with aspects of the present disclosure there is provided an apparatus configured for use with an energy management system. The apparatus comprises an energy scheduling optimization module configured to automatically receive site information, perform energy scheduling optimization for a load based on the site information, and generate a recommended energy schedule for the load based on the energy scheduling optimization.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure;

FIG. 3 is a flowchart of a method configured for use with the energy management system of FIG. 1, in accordance with one or more embodiments of the present disclosure;

FIGS. 4A and 4B are diagrams of system architecture flow, in accordance with one or more embodiments of the present disclosure;

FIG. 5 is a diagram of a three-stage simulation engine, in accordance with one or more embodiments of the present disclosure;

FIG. 6 is a diagram of deployment architecture, in accordance with one or more embodiments of the present disclosure;

FIGS. 7A to 7E are diagrams of screenshots, in accordance with one or more embodiments of the present disclosure; and

FIGS. 8A to 8E are diagrams of screenshots, in accordance with one or more embodiments of the present disclosure.

### DETAILED DESCRIPTION

Embodiments of the present disclosure provide methods and apparatus configured for smart scheduling for appliances of energy management system. For example, an apparatus configured for use with an energy management system can comprise an energy scheduling optimization module configured to automatically receive site information, perform energy scheduling optimization for a load based on the site information, and generate a recommended energy schedule for the load based on the energy scheduling optimization. When compared to conventional methods and apparatus configured for use with energy management systems, the methods and apparatus described herein provide appliance level optimization and control via application software (e.g., Enphase Enlighten app, available from Enphase Energy Inc). Further, the methods and apparatus described herein provide accuracy and speed of optimization. That is, the algorithm(s) described herein uses machine learning based site-specific photovoltaic (PV) and consumption forecast. Moreover, the algorithm(s) described herein is scientific, scalable and extendable to all loads/devices of an energy management system (e.g., appliance level optimization).

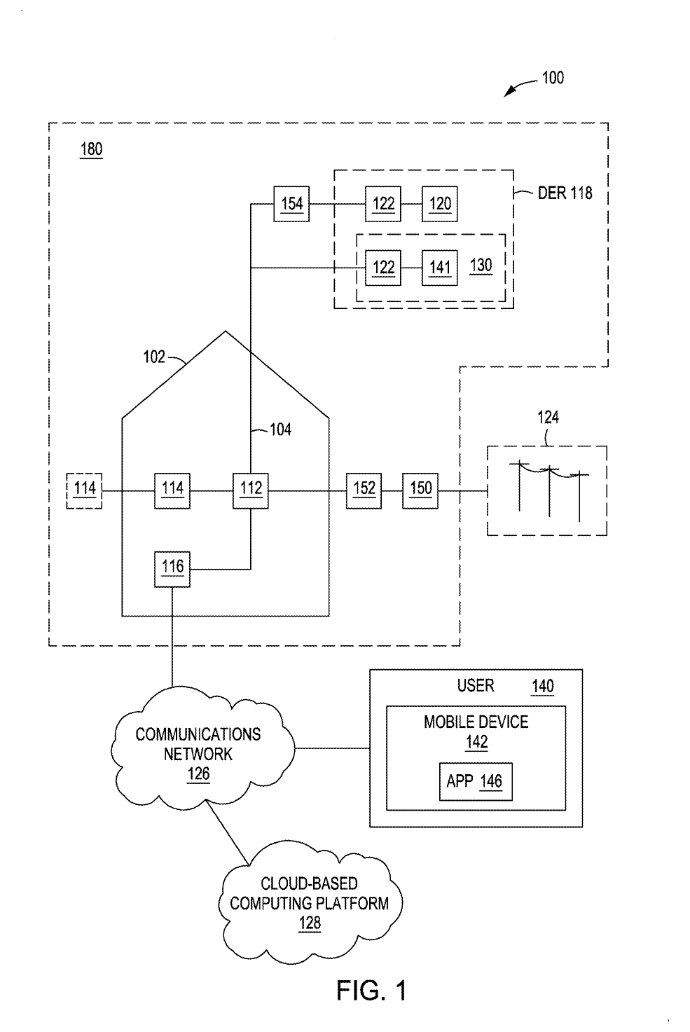

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems. The methods and apparatus described herein use one or more algorithms configured for use with an energy management system (e.g., the system 100).

For example, the system 100 comprises a structure 102 (e.g., a user’s structure), such as a residential home, commercial building, or separate mounting structure, having an associated DER 118 (distributed energy resource). The DER 118 can be situated external or internal to the structure 102. For example, the DER 118 as solar power may be located on the roof of the structure 102 or can be part of a solar farm or DER 118 as battery can be situated inside the residential home The structure 102 comprises one or more loads 114 (and/or energy storage devices), e.g., appliances, electric hot water heaters, thermostats/detectors, boilers, electric vehicle supply equipment (EVSE), water pumps, and the like), which can be located within or outside the structure 102, and a DER controller 116, each coupled to a load center 112 (e.g., a main panel). Although the energy storage devices, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the energy storage devices, DER controller 116, DER 118, load center 112, generation meter 154, the meter 152, and the MID 150 are part of a microgrid 180 (e.g., when the system 100 is not connected to the grid 124). It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one or many-to-one or one-to-many or any other configuration). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one (or two-to-one or many-to-one or one-to-many or any other configuration) correspondence, where each pair of power conditioner 122 and a corresponding battery may be referred to as an AC battery.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., appliances, EV, EVSE) and/or the energy storage devices. In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bi-directional inverter such as a simple charger onboard an EV. An aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway or combiner or a BiDi EVSE (which includes a gateway and consolidates interconnection equipment into a single enclosure and streamlines PV and storage installations by providing a consistent, pre-wired solution for residential applications). The DER controller 116 receives data (e.g., alarms, messages, operating data, performance data, and the like) from the power conditioners 122 and communicates the data and/or other information via the communications network 126 to a cloud-based computing platform 128, which can be configured to execute one or more application software, e.g., a smart scheduling application (algorithm), a grid connectivity control application, to a mobile app, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a smart scheduling application (algorithm), a grid connectivity control application) for performing one or more of the functions described herein. For example, the DER controller 116 can include a memory (e.g., a non-transitory computer readable storage medium) having stored thereon instructions that when executed by a processor perform a method that is configured to provide energy scheduling optimization for a load (e.g., the one or more loads 114 (and/or energy storage devices)) based on site information (e.g., at least one of historical site telemetry data, site metadata, site tariff data, mode of operation, appliance runtime and average power consumption, or previously scheduled loads), as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kW) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself. The generation meter 154 can be internal or external to the DER controller 116.

The meter 152 may be any suitable energy meter that measures the energy consumed/imported by the system 100, such as a net-metering meter, a bi-directional meter that measures energy imported from the grid 124 and as well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kW), reactive power flow (kVAR), grid frequency, and grid voltage. The meter 152 measures power flows independently of MID state, i.e., when MID is closed and DER’s are connected to the grid and when MID is open and DER’s are isolated from the grid. The meter 152 can be internal or external to the DER controller 116.

The MID 150, which may also be referred to as an island interconnect device (IID), connects/disconnects the system 100 to/from the grid 124. That is, when the system 100 is disconnected from the grid 124, the system 100 becomes a microgrid. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122 and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124. The MID 150 can be internal or external to the DER controller 116.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, laptop or the like) communicably coupled by wireless/ wired means to the communications network 126. The mobile device 142 has a CPU, support circuits, and memory, and has one or more applications (e.g., a grid connectivity control application (an application 146)) installed thereon for controlling the connectivity with the grid 124, as described herein. The may run on commercially available operating systems, such as IOS, ANDROID, WINDOWS and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate. Additionally, the DER controller 116 can communicate instructions to the EVSE and/or the EV, e.g., directly or indirectly via the communications network 126.

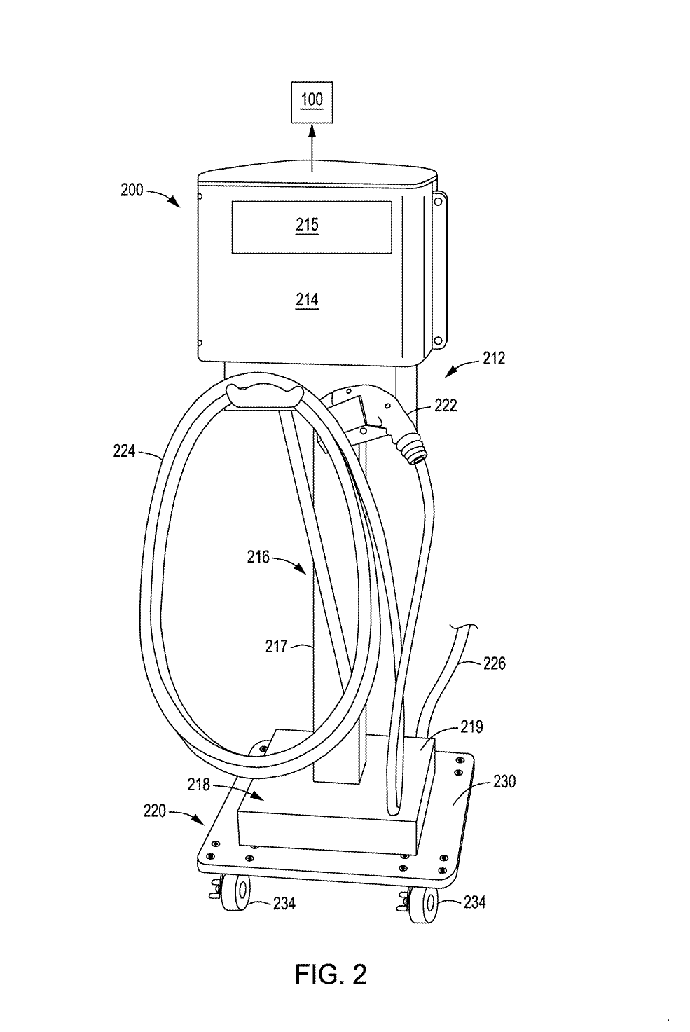

FIG. 2 is a diagram of an EVSE system ( a system 200), in accordance with one or more embodiments of the present disclosure. As shown in FIG. 2, the system 200 is configured to connect to the system 100 and comprises electric vehicle supply equipment 212, a housing enclosure 214, a pedestal 216 having a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown) to an EV (not shown), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100. In addition, system 200 can have additional connection points to connect different DERs and Loads (similar to DER controller 116).

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example but not limited to, a CS Series Public EVSE provided by ClipperCreek, Inc. of Auburn, Calif.

As described above, inventive concepts described herein provide improved methods and apparatus configured for smart scheduling for appliances of energy management systems. For example, the algorithms described herein use a machine learning and mathematical optimization-based model for user specific and appliance based smart scheduling and control mechanism in one or more applications (e.g., the application 146). Additionally, in at least some embodiments, proprietary site-level consumption and production forecasts can be used as an input to model the uncertainties in forecasts which then can be used in the algorithm to ensure that an error in forecasts does not deteriorate the algorithm's performance.

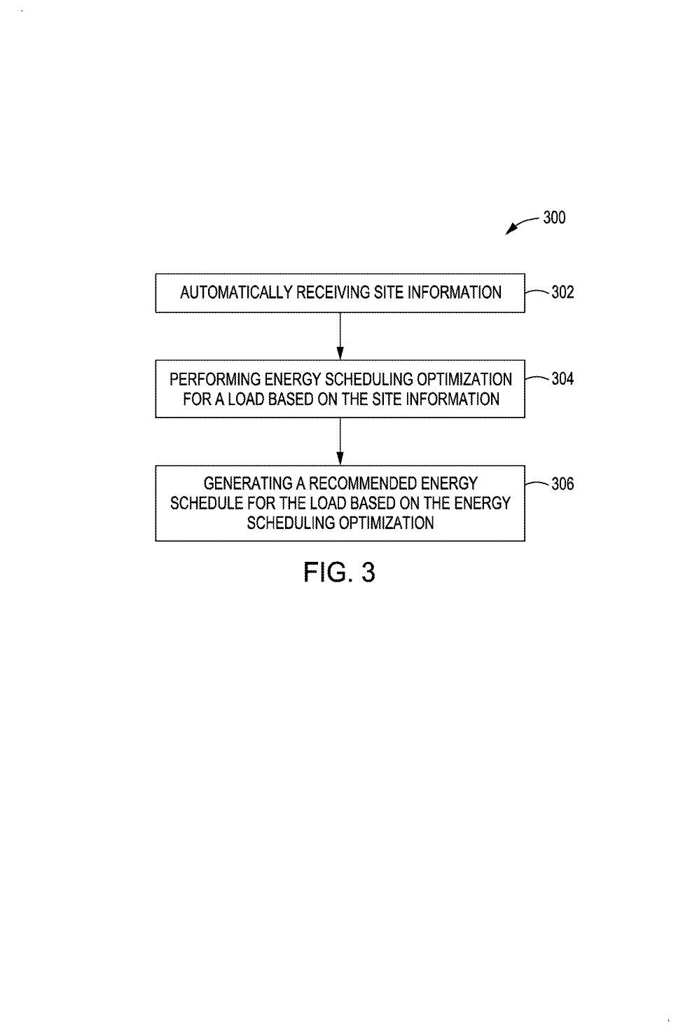

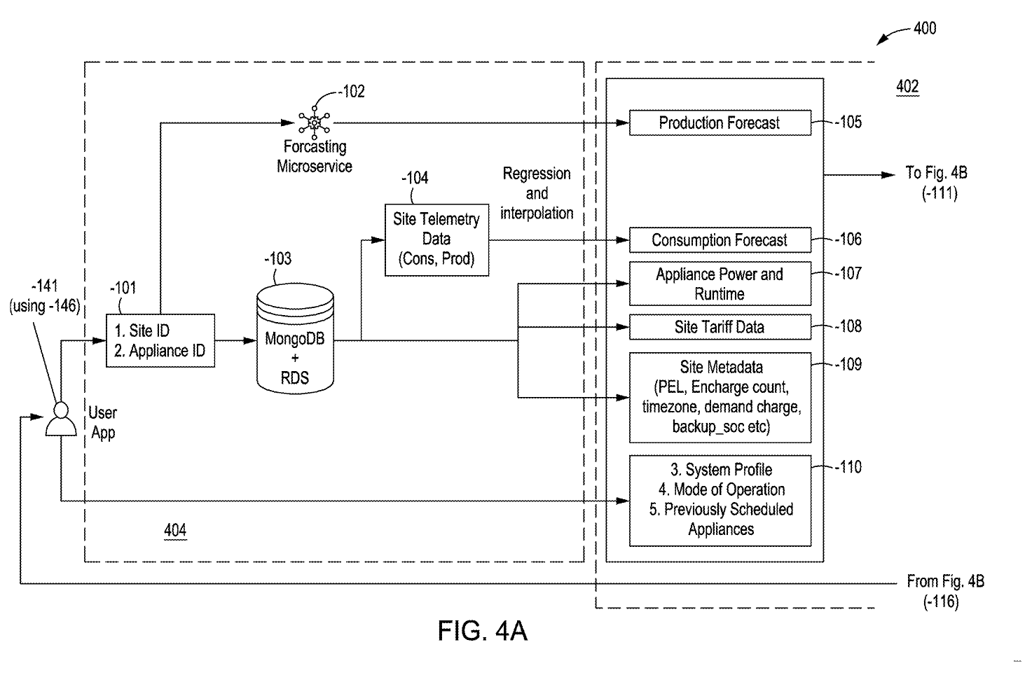

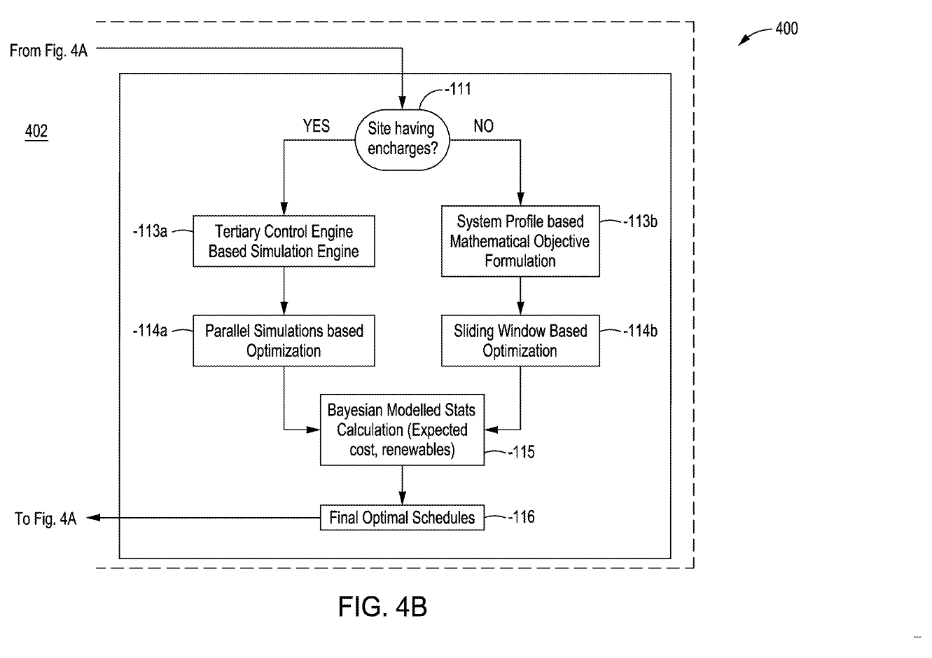

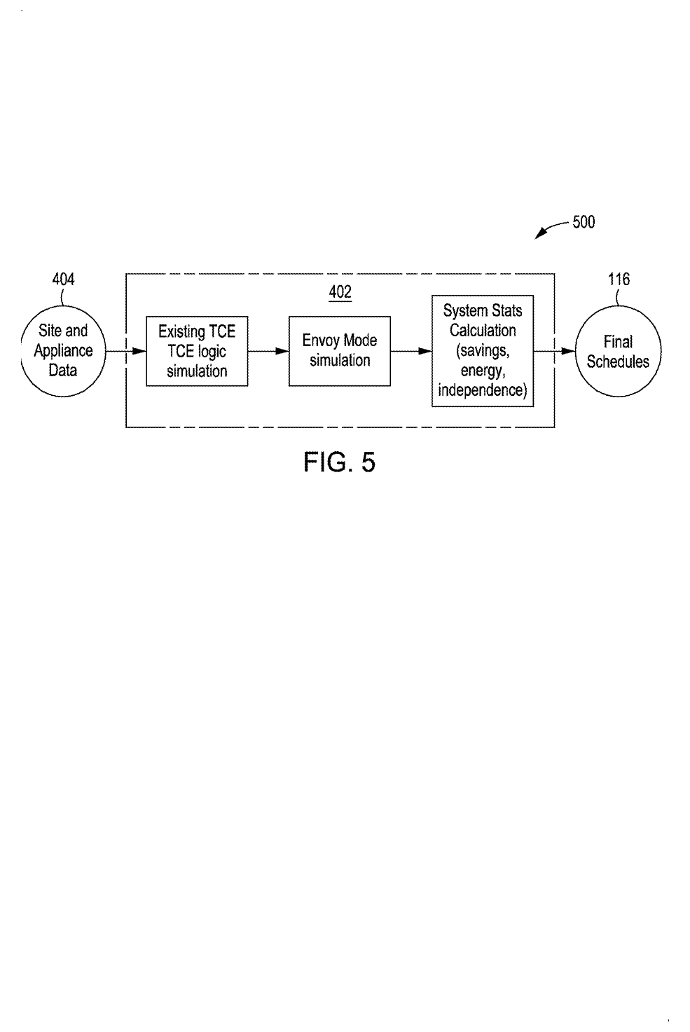

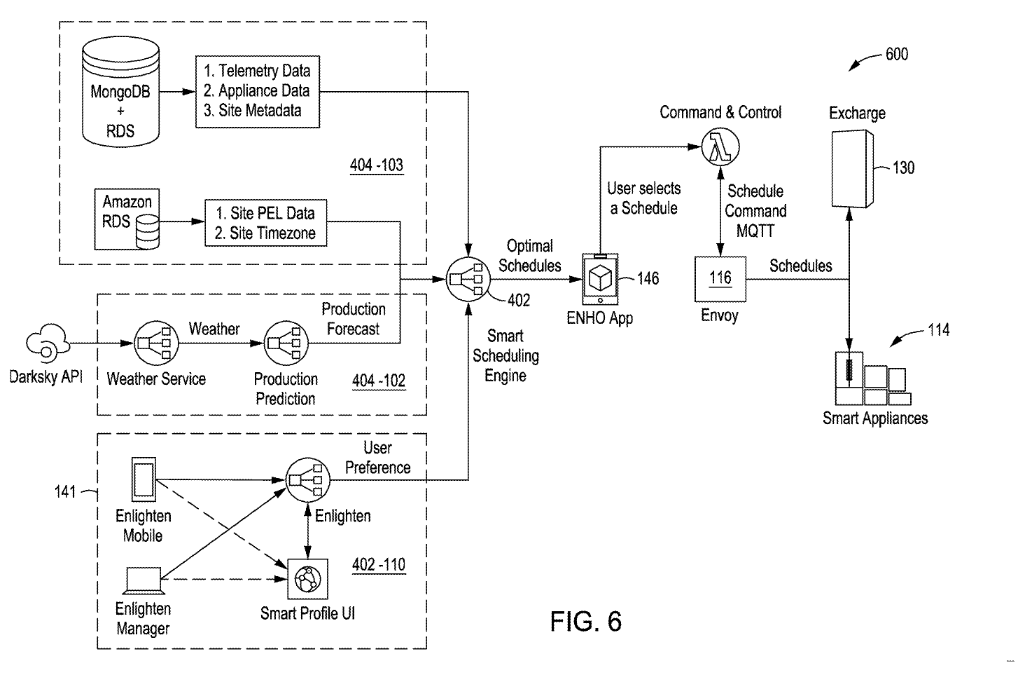

For example, FIG. 3 is a flowchart of a method 300 configured for use with the energy management system of FIG. 1, FIGS. 4A and 4B are diagrams of system architecture flow 400, FIG. 5 is a diagram of a three-stage simulation engine 500, and FIG. 6 is a diagram of deployment architecture 600, all in accordance with one or more embodiments of the present disclosure.

For example, at 302, the method 300 comprises automatically receiving site information via a controller/gateway (e.g., the DER controller 116). For example, a controller/gateway can provide site information 404 to the energy scheduling optimization application 402 (e.g., the application 146). Alternatively or additionally, the site information can be provided manually via a user (e.g., the user 140, (see FIGS. 4A and 6)).

In at least some embodiments, the site information 404 comprises, but is not limited to, historical site telemetry data, user preferences, site metadata, site tariff data, appliance date, mode of operation, appliance runtime and average power consumption, previously scheduled loads, site PEL data, site time zone, weather data, production/consumption data, etc. (see FIGS. 4A-6).

In at least some embodiments, the site information can comprise site ID and appliance ID information 404-101 which can be provided by a user and inputted to a forecasting microservice 404-102 and to one or more databases 404-103 (e.g., Mongo DB, Amazon relational database (RDB)), see FIGS. 4A and 6. The forecasting microservice 404-102 can transmit/provide the forecasting information to a production forecast module 402-105 of the energy scheduling optimization application 402 see FIGS. 4B and 6. Similarly, the one or more databases 402-103 can transmit/provide the information stored therein to a site telemetry data module 404-104, which can use consumption/production information to perform regression/interpolation analysis. The regression/interpolation analysis can be transmitted/provided to a consumption forecast module 402-106 of the energy scheduling optimization application 402. Likewise, the one or more databases 402-103 can transmit/provide the information stored therein to an appliance power runtime module 402-107, a site tariff data module 402-108, and a site metadata module 402-109 (e.g., PEL, battery charge, battery charge count, time zone, demand charge, backup state-of-charge (SOC), etc.) of the energy scheduling optimization application 402. Similarly, the user can transmit/provide information (e.g., system profile, mode of operation, previously scheduled appliances, etc.) to a user information module 402-110 of the (see FIGS. 4B and 6) of the energy scheduling optimization application 402.

Next, at 304, the method 300 comprises performing energy scheduling optimization for a load (e.g., appliance) based on the site information, and at 306, generating the recommended energy schedule for the load based on the energy scheduling optimization. For example, the energy scheduling optimization application 402 uses the information provided at 302. For example, in at least some embodiments, the energy scheduling optimization application 402 can use the a) historical site telemetry data (e.g., consumption, PV, battery charge/discharge, etc.), b) site metadata, such as, energy storage system count, time zone, system profile, backup SOC, power export limit etc., c) site tariff data and/or mode of operation, d) appliance runtime and average power consumption of the appliance, and/or e) previously scheduled appliances, their runtime and power (if any) to generate the energy scheduling optimization for the load.

In at least some embodiments, at 306, the method 300 can comprise determining if there is storage at the site (see 402-111). If yes at 402-111, the energy scheduling optimization application 402 performs tertiary control based simulation at 402-113a. Next, at 402-114a, the energy scheduling optimization application 402 performs parallel simulation based optimization. Next, at 402-115, the energy scheduling optimization application 402 performs Bayesian modelled statistical calculations (e.g., expected cost, renewables, etc.). And, at 402-116, outputs the generated recommended energy schedule for the load based on the energy scheduling optimization.

If no at 402-111, the energy scheduling optimization application 402 performs system profile based mathematical objective formulations/calculations at 402-113b. Next, at 402-114b, the energy scheduling optimization application 402 performs sliding window based optimization. Next, at 402-115, the energy scheduling optimization application 402 performs Bayesian modelled statistical calculations (e.g., expected cost, renewables, etc.). And, at 402-116, outputs the generated recommended energy schedule for the load based on the energy scheduling optimization.

After 402-116, the generated recommended energy schedule for the load(s) can be transmitted from the energy scheduling optimization application 402 to the user and/or the controller/gateway (e.g., the DER controller 116) of the energy management system. For example, the energy scheduling optimization for the load can comprise, but is not limited to, a) optimal start times (e.g., three times, four times, five times, etc.) of the appliance (e.g., in the next twenty four (24) hours (twenty four hour period), thirty six (36) hours, etc.), b) expected import cost for an appliance for each start time, and/or c) expected percentage (%) of renewable consumption for appliance for each start time.

The inventors have found that by using the one or more of the inputs and/or outputs, the methods and apparatus described herein can be configured for savings optimization which can minimize a cost of running the appliance during off-peak period and can minimize grid import. For systems w/o a current transformer (CT), home load consumption can be treated as zero.

Additionally, the methods and apparatus described herein are operable in a self-consumptions mode and savings mode. In both modes, system behavior, as per a set profile, can be factored in for systems with storage (e.g., the battery 141). When other appliances are scheduled, then consumption by the scheduled device can be factored in. In at least some embodiments, a schedule(s) can be within the next 24 hrs. In at least some embodiments, when a optimization result is identical during a continuous period, the most recent time can be used. e.g., if anytime between 3 pm-6 pm gives the same effect, then 3 pm can be recommended. In at least some embodiments, a response can have at least one suggested time. Alternatively or additionally, a response can have multiple suggested times when other requests are within a tolerance limit. For example, a tolerance limit can be a percent (%) value based on profile mode. For example, in at least some embodiments, when in best schedule mode, a tolerance limit can be equal to 5%, a bill value for using a DER in the best schedule mode can be equal to $100, and an energy independence for using the DER in best schedule mode can be 50%. Likewise, in at least some embodiments, when in savings mode, recommended schedules can be where a bill value is between $95 and $105 (e.g., 100 +/- 5% of 100). For self-consumption, recommended schedules can be where energy independences are between 47.5% and 52.5% (e.g., <= 50 +/- 5% of 50).

In at least some embodiments, three schedules can be suggested, and the schedules can be spaced apart by a specified time frame, which can be inputted by a user or calculated by the algorithm. In at least some embodiments, the schedules can be spaced at least 30 minutes apart. Additionally, in at least some embodiments, a latest schedule can be at least 15 minutes from a current time, as per a time zone passed/provided in the request.

The algorithm(s) described herein provide user level customization. For example, a recommended schedule takes into account a user’s consumption and production, site level configurations, and/or user profile modes, and generates personalized recommendations for each appliance. In addition to the algorithm determining (mathematically) the best time slots (e.g., three) to use an appliance, the algorithm spaces the time slots out, keeping in mind the end-user scheduling convenience.

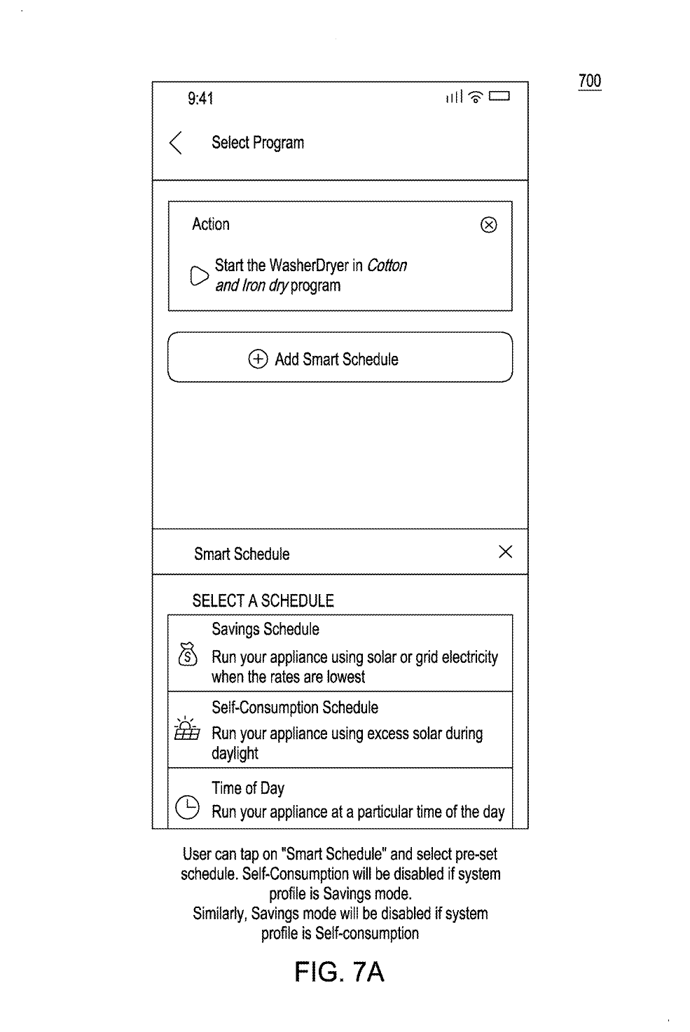

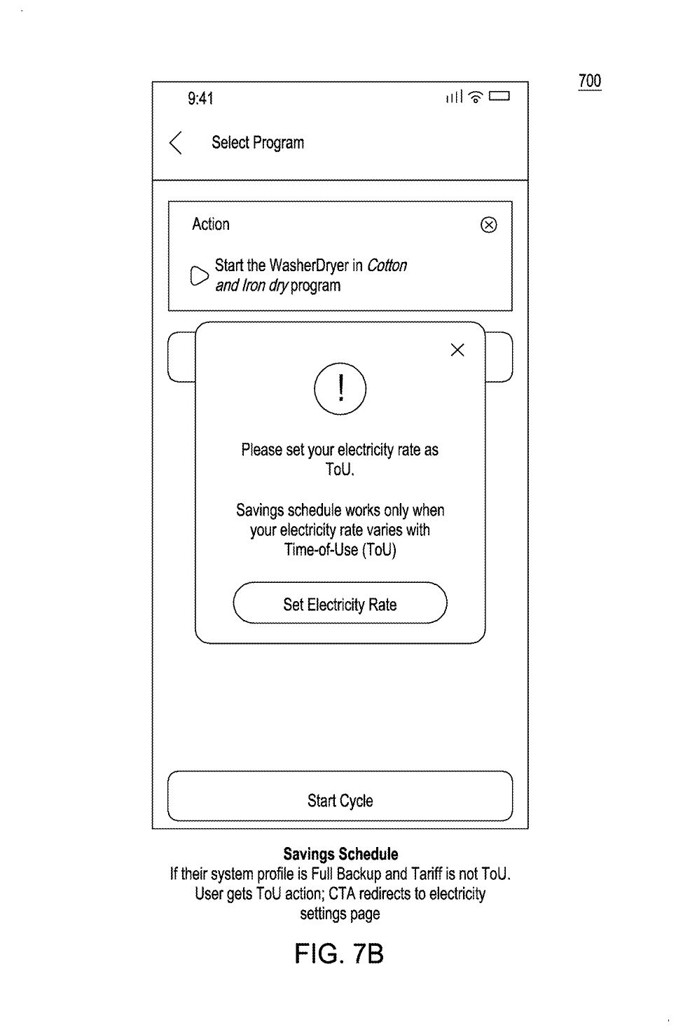

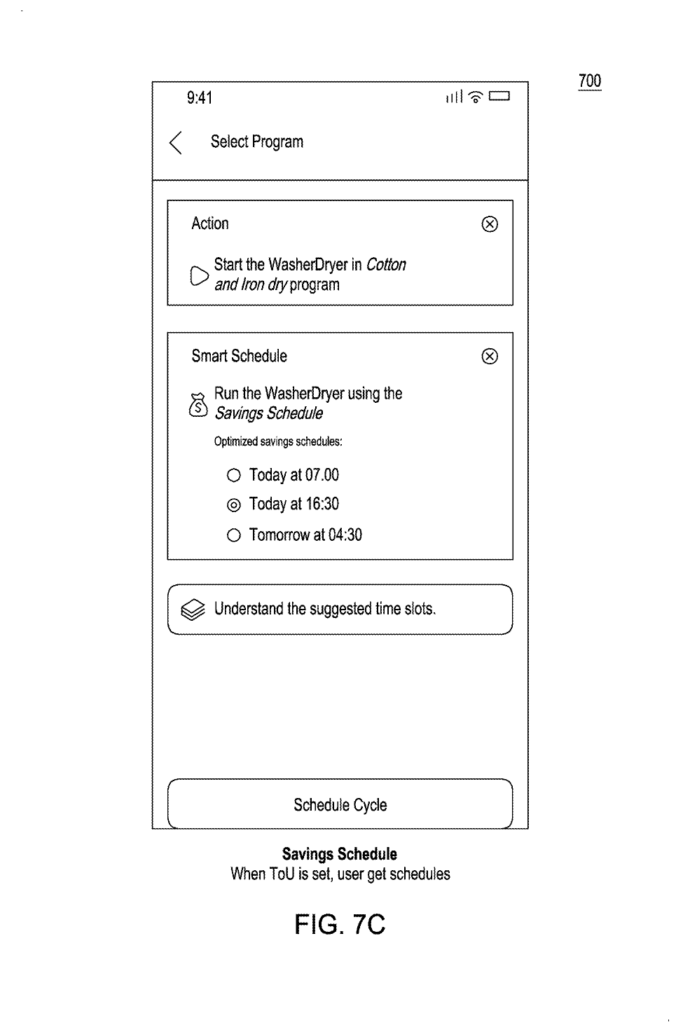

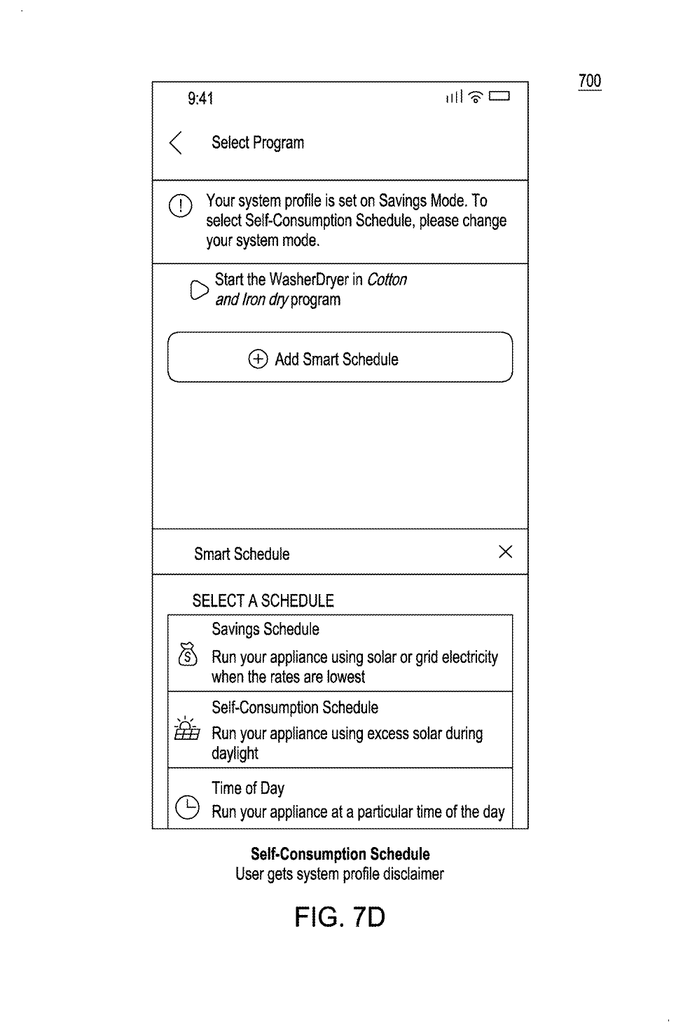

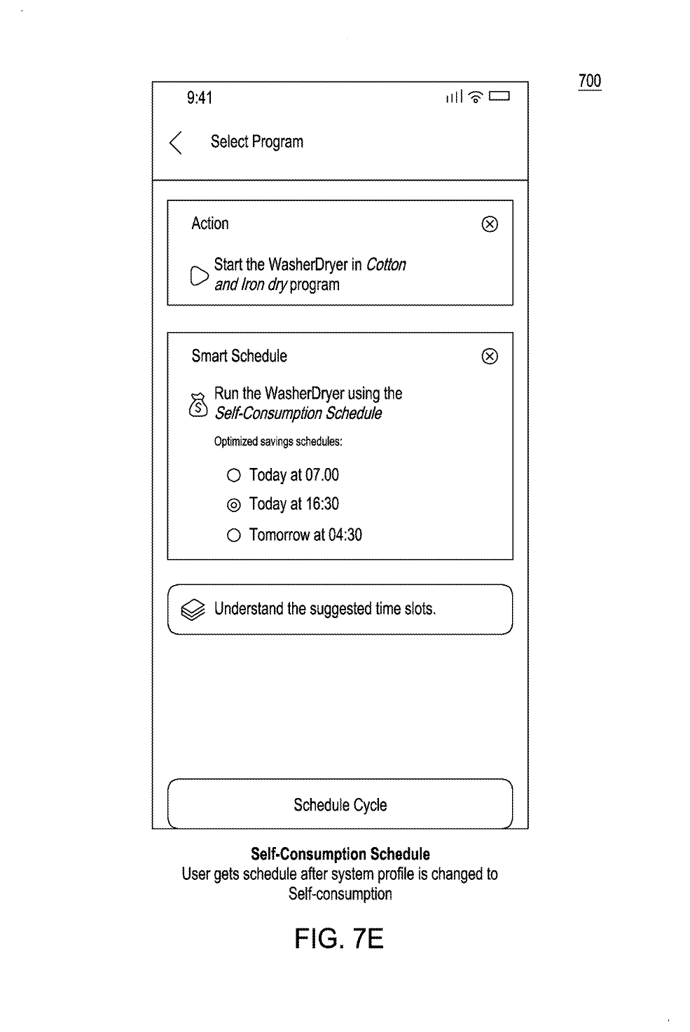

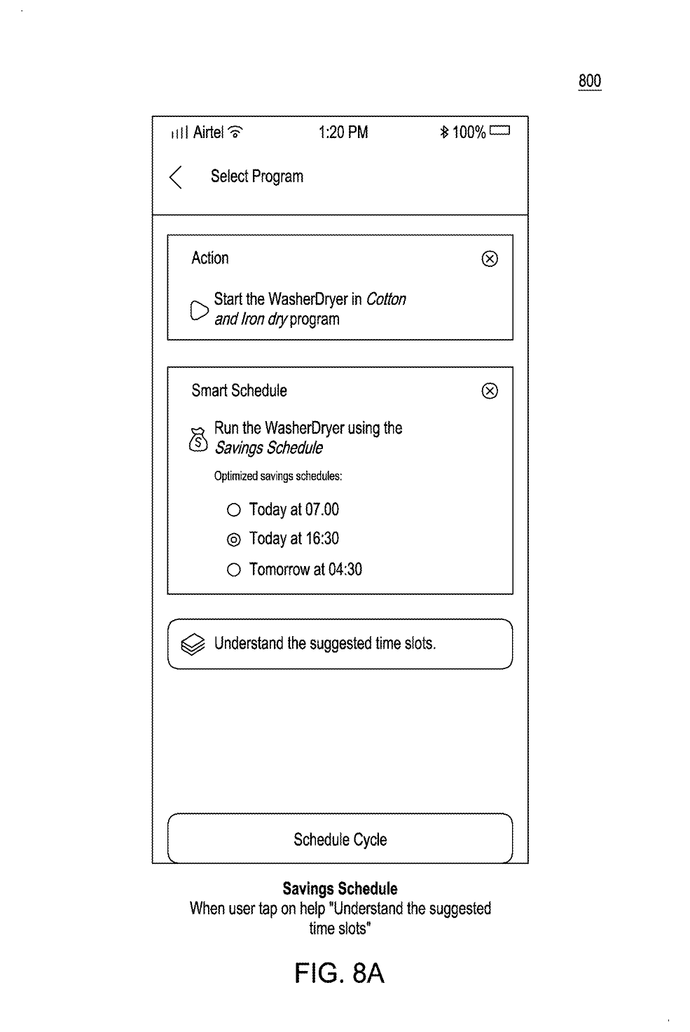

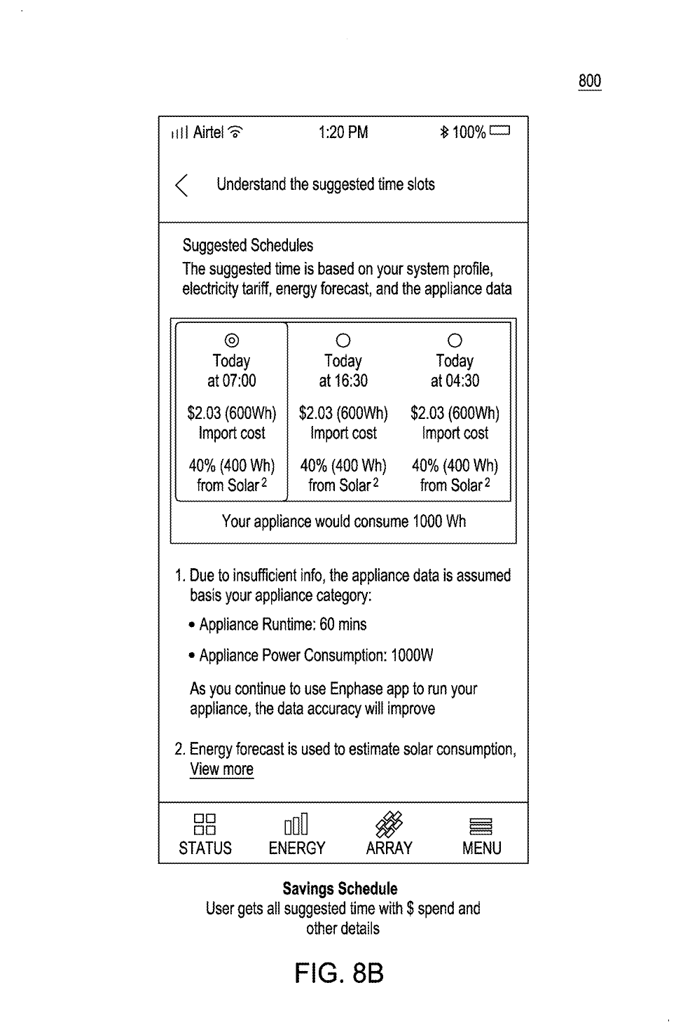

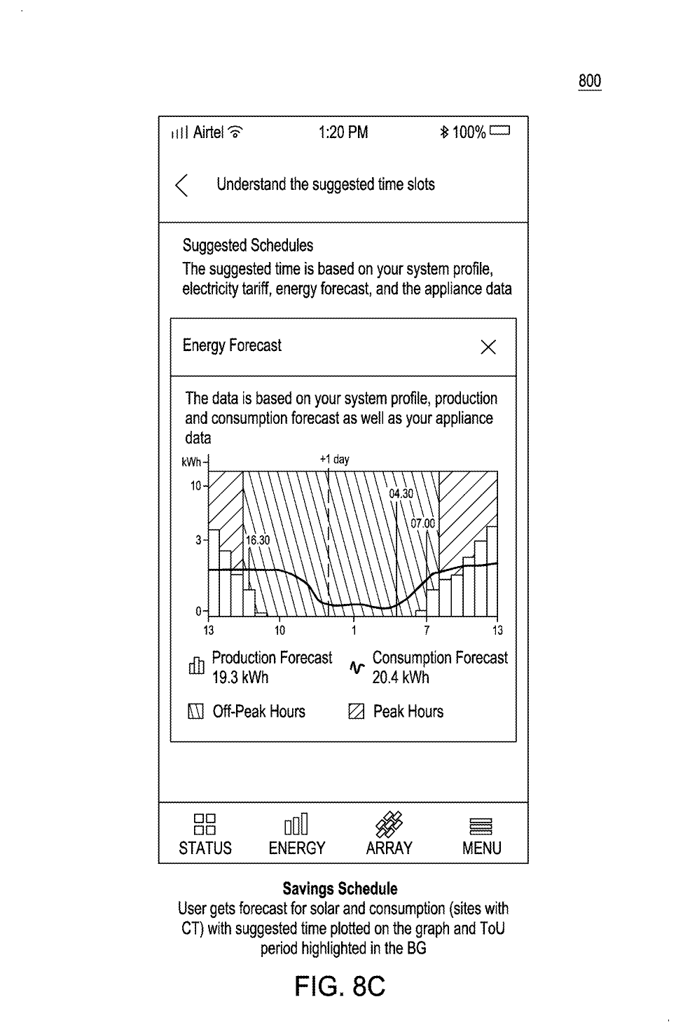

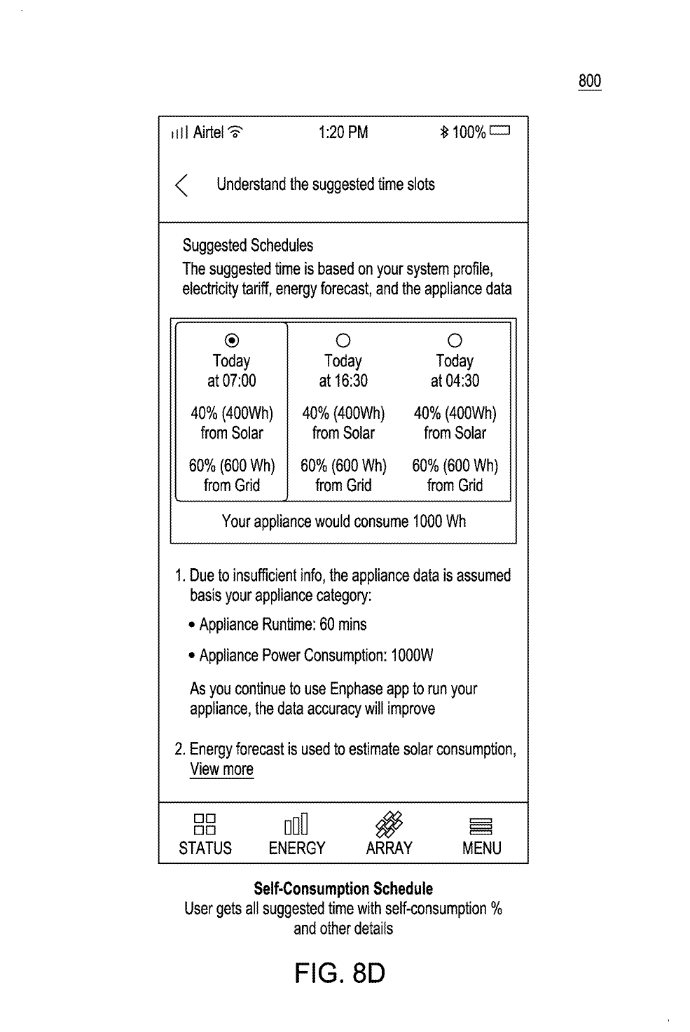

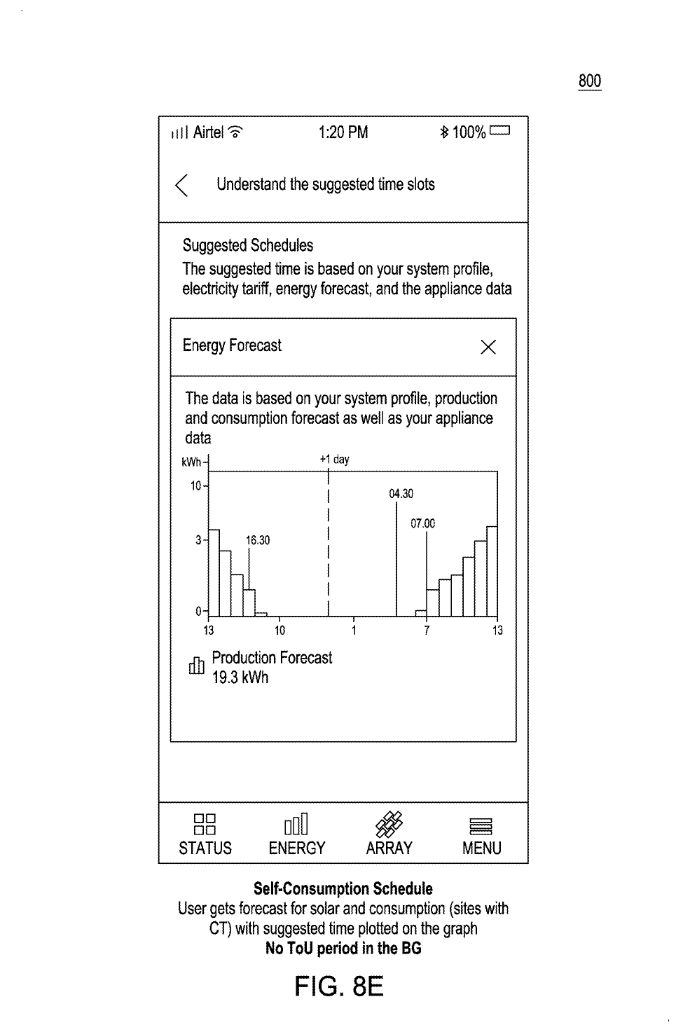

FIGS. 7A to 8E are diagrams of screenshots 700 and 800, respectively, in accordance with one or more embodiments of the present disclosure. For example, for a homeowner, the algorithm provides optimized site performance in terms of both bill value (e.g., savings schedule and self-consumption schedule) and green energy usage, reduces a complexity and manual effort of operation (e.g., switching ON/OFF, changing washer-dryer modes etc.) of appliances, and provides a more immersive experience and control in scheduling and monitoring the appliances at home. For a home energy management system (HEMS) ecosystem, the algorithm provides an integral addition to HEMS ecosystem by knowing the usage times for large loads, which can aid in production forecast, thus, further enhancing the site-level optimization program. Moreover, the algorithm provides device level data and cross selling by giving a manufacturer the information on the exact set of appliances and the appliance usage times at a home and can provide a unique scope of cross-selling of appliances, e.g., sites with EVs having one type of EV charger can be targeted for a different type of charger.

While the foregoing is directed to embodiments of the present disclosure, other and further embodiments of the disclosure may be devised without departing from the basic scope thereof, and the scope thereof is determined by the claims that follow.

What is claimed is:

1. A non-transitory computer readable storage medium having instructions stored thereon that when executed by a processor performs a method for optimizing efficient use of energy via smart scheduling of loads, comprising:
automatically receiving site information;
performing energy scheduling optimization for a load based on the site information; and
generating a recommended energy schedule for the load based on the energy scheduling optimization.

2. The non-transitory computer readable storage medium of claim 1, wherein the site information comprises at least one of historical site telemetry data, site metadata, site tariff data, mode of operation, appliance runtime and average power consumption, or previously scheduled loads.

3. The non-transitory computer readable storage medium of claim 2, wherein the historical site telemetry data comprises at least one of consumption, photovoltaic (PV), or battery charge/discharge.

4. The non-transitory computer readable storage medium of claim 2, wherein the site metadata comprises at least one of battery charge count of a battery, time zone, system profile, backup state-of-charge (SOC) of the batter, or power export limit.

5. The non-transitory computer readable storage medium of claim 2, wherein the previously scheduled loads comprises at least one of runtime or power of the loads.

6. The non-transitory computer readable storage medium of claim 1, wherein the recommended energy schedule comprises at least one of optimal start times of the load, expected import cost for the load for each optimal start time, or expected percentage of renewable consumption for the load for each optimal start time.

7. The non-transitory computer readable storage medium of claim 6, wherein the optimal start times of the load is three times within a twenty four hour period.

8. A method for optimizing efficient use of energy via smart scheduling of loads, comprising:
automatically receiving site information;
performing energy scheduling optimization for a load based on the site information; and
generating a recommended energy schedule for the load based on the energy scheduling optimization.

9. The method of claim 8, wherein the site information comprises at least one of historical site telemetry data, site metadata, site tariff data, mode of operation, appliance runtime and average power consumption, or previously scheduled loads.

10. The method of claim 9, wherein the historical site telemetry data comprises at least one of consumption, photovoltaic (PV), or battery charge/discharge.

11. The method of claim 9, wherein the site metadata comprises at least one of battery charge count of a battery, time zone, system profile, backup state-of-charge (SOC) of the batter, or power export limit.

12. The method of claim 9, wherein the previously scheduled loads comprises at least one of runtime or power of the loads.

13. The method of claim 8, wherein the recommended energy schedule comprises at least one of optimal start times of the load, expected import cost for the load for each optimal start time, or expected percentage of renewable consumption for the load for each optimal start time.

14. The method of claim 13, wherein the optimal start times of the load is three times within a twenty four hour period.

15. An apparatus configured for use with an energy management system, comprising:
an energy scheduling optimization module configured to:
automatically receive site information;
perform energy scheduling optimization for a load based on the site information; and
generate a recommended energy schedule for the load based on the energy scheduling optimization.

16. The apparatus of claim 15, wherein the site information comprises at least one of historical site telemetry data, site metadata, site tariff data, mode of operation, appliance runtime and average power consumption, or previously scheduled loads.

17. The apparatus of claim 16, wherein the historical site telemetry data comprises at least one of consumption, photovoltaic (PV), or battery charge/discharge.

18. The apparatus of claim 16, wherein the site metadata comprises at least one of battery charge count of a battery, time zone, system profile, backup state-of-charge (SOC) of the batter, or power export limit.

19. The apparatus of claim 16, wherein the previously scheduled loads comprises at least one of runtime or power of the loads.

20. The apparatus of claim 15, wherein the recommended energy schedule comprises at least one of optimal start times of the load, expected import cost for the load for each optimal start time, or expected percentage of renewable consumption for the load for each optimal start time.
